(19) United States
(12) Patent Application Publication
(10) Pub. No.: US 2026/0200357 A1
(43) Pub. Date: Jul. 16, 2026

(54) Method and System for Matching a Position of a Vehicle With a Zone Within a Surroundings Map

(71) Applicant: Bayerische Motoren Werke Aktiengesellschaft, Muenchen (DE)

(72) Inventor: Andreas KOPP, Hoehenkirchen-Siegertsbrunn (DE)

(21) Appl. No.: 19/445,907

(22) Filed: Jan. 12, 2026

(30) Foreign Application Priority Data
Jan. 14, 2025 (DE) 10 2025 101 186.9

(51) Int. Cl. B60L 53/35; B60L 53/68; H04L 9/32

(52) U.S. Cl. CPC B60L 53/35; B60L 53/68; H04L 9/3239; H04L 2209/42; H04L 2209/84

(57) ABSTRACT

The present disclosure relates to a method and a system for matching a position of a vehicle with a rectangular zone within a surroundings map, wherein an intelligent charging function of a charging station for charging a battery of the vehicle, is available in the rectangular zone, the method comprising the following steps: providing anonymized position information of the rectangular zone; providing two-dimensional offset information for the rectangular zone; providing position information of the vehicle within the surroundings map; determining offset position information of the vehicle using the reciprocal two-dimensional offset information; generating anonymized offset position information for the offset position information of the vehicle by hashing a grid element representing the offset position information by means of a cryptographic algorithm; and comparing the anonymized position information of the rectangular zone with the anonymized offset position information of the vehicle.

### CROSS REFERENCE TO RELATED APPLICATION

This application claims priority under 35 U.S.C. §119 from German Patent Application No. DE 10 2025 101 186.9, filed January 14, 2025, the entire disclosure of which is herein expressly incorporated by reference.

### BACKGROUND AND SUMMARY

The disclosure relates to a method for anonymized matching of a position of a vehicle with a rectangular zone within a surroundings map. The disclosure also relates to a system for anonymized matching of a position of a vehicle with a rectangular zone within a surroundings map.

The increasing use of electric vehicles and the growing availability of dynamic electricity rates require intelligent solutions for optimizing charging procedures. In particular in the home area, there is a high demand for systems which can control charging procedures cost-effectively in that they take into consideration the electricity prices in real time. The goal is to increase the attractiveness and acceptance of such solutions by making them accessible for a broad target group – independently of the charging technology used and its producer.

This is addressed in particular by the introduction of so-called “backend charging”. In this case, the charging procedures are not controlled via a producer-specific wall box, but rather directly via the backend of the vehicle producer. The charging signals and charging plans are transmitted wirelessly to the vehicle in this case and executed there. This architecture enables intelligent charging procedures to be implemented also using charging stations, for example, wall boxes, of third-party providers and thus enables the user base to be substantially expanded. One element of this solution is the ability to identify the location of the vehicle and establish whether it is at a location (also called “zone”), at which an intelligent charging plan is available.

A typical scenario is the home area, in which the vehicle owner has concluded a dynamic electricity rate, which assists intelligent, in particular cost-optimized charging plans. Alternatively, such zones can also exist at other locations, such as the workplace. In general, a method in which GPS coordinates having a radius of, for example, 30 m accuracy are defined as a zone is used in the prior art to determine whether a vehicle is located in such a zone. A vehicle is then considered to be within the zone when its current GPS coordinates are within this radius.

This conventional method has significant challenges with respect to data protection, however. This is because the zone coordinates are typically linked with a unique vehicle identifier (such as the VIN), which could disclose sensitive information such as the residential address of the vehicle owner.

A solution is therefore desired which enables zone information to be stored in an anonymized manner without impairing the functionality of the zone monitoring at the same time.

An object of the present invention is to specify a method and a system for intelligent charging of a vehicle which addresses the above-mentioned challenges, and in particular specifies a solution improved with respect to data protection law.

This object is addressed by the subjects of the independent claims. Advantageous designs of the invention are specified in the dependent claims.

The invention relates to a computer-implemented method for anonymized matching of a position of a vehicle with a position area of a rectangular zone within a surroundings map. An intelligent charging function of a charging station for charging a battery of the vehicle or another function for the vehicle is available or can be used by the vehicle in the rectangular zone. The intelligent charging function enables, for example, time-optimized and/or cost-optimized charging of the battery of the vehicle. Another function can be that a pharmacy, a police station, a shop, or another address of interest for the driver of the vehicle, such as a navigation destination, is in the position area of the rectangular zone.

The method comprises the following steps: providing anonymized position information of the rectangular zone, wherein the anonymized position information of the rectangular zone is generated by hashing a grid element representing the rectangular zone by means of a cryptographic algorithm; providing two-dimensional offset information for the rectangular zone, wherein the two-dimensional offset information describes an offset between a center point of the grid element representing the rectangular zone and a center point of the rectangular zone; providing position information of the vehicle within the surroundings map; determining offset position information of the vehicle using the reciprocal two-dimensional offset information; generating anonymized offset position information to the offset position information of the vehicle by hashing a grid element representing the offset position information by means of a cryptographic algorithm; and comparing the anonymized position information of the rectangular zone with the anonymized offset position information of the vehicle for the anonymized matching of the position of the vehicle with the position area of the rectangular zone. If the anonymized position information of the rectangular zone corresponds with the anonymized offset position information of the vehicle, it is assumed that the position of the vehicle is within the position area of the rectangular zone. The position of the vehicle is then considered to be matched with the position area of the rectangular zone.

The anonymized position information describes a geographic position which is represented so that the private sphere of a user is preserved, or in the present case an actual location of the zone or the geographic coordinates of the zone for the environment remain unknown. The accurate position of the zone is not directly specified here, but rather replaced by an abstracted representation.

The rectangular zone within a surroundings map is a defined rectangular area which is defined in a map and within which the precise position of the charging station is located. This zone is used as the foundation for specifying a position of the charging station not exactly, but only in the scope of this predefined tolerance area.

The hashing of a grid element representing the rectangular zone by means of a cryptographic algorithm describes the process in which a grid element that represents the rectangular zone is converted by a cryptographic algorithm into an encrypted character chain. This process ensures that the position information is anonymized since the resulting character chain does not permit inferences about the exact coordinates within the zone or on the representing grid element. In combination, these methods enable a position to be specified on a map in abstracted form without the private sphere of the affected party being endangered. The representing grid element is preferably located at a position defined by the rasterization algorithm and thus predetermined within a predetermined rasterization of a map, by which the surroundings are mapped.

The two-dimensional offset information describes the offset between the center point of the rectangular grid element representing the rectangular zone and a center point of the rectangular zone. The offset is preferably performed here within the plane of the rasterization of the surroundings. In this case, for example, starting from the center point of the rectangular grid element representing the rectangular zone, the offset to the center point of the rectangular zone can be determined by computer in two predetermined navigation directions, such as north and east, or south and west, or north and west, or south and east. The two predetermined navigation directions preferably define the two dimensions of the two-dimensional offset information. The two predefined navigation directions are preferably aligned orthogonally to one another within a plane of the rasterization. Alternatively, the offset between the center point of the rectangular grid element representing the rectangular zone and the center point of the rectangular zone can be determined with a distance and an angle of the two positions of the center point in relation to one another. The offset can thus be defined by means of preferably Cartesian two-dimensional coordinates or polar coordinates. Three-dimensional Cartesian coordinates or spherical coordinates can also be used for determining the offset with the option of conversion into two dimensions. The offset information is determined starting from the center point of the grid element preferably closest to the zone. A matching zoom level is selected here with regard to a zone size, so that the grid element size(s) preferably correspond essentially, i.e. up to ±30%, to a zone size. The two-dimensional offset information is preferably stored unencrypted as real length specifications in the two dimensions jointly with the anonymized position information.

The position information of the vehicle within the surroundings map can be provided, for example, by providing GPS coordinates of the vehicle or by providing other geographic information describing a position of the vehicle.

The determination of the offset position information of the vehicle preferably describes a process in which the current position of the vehicle is determined relative to the anonymized position. This is carried out by using reciprocal, two-dimensional offset information which specifies the difference between the reference position and the actual position of the vehicle in two dimensions, in the present case in two (map) navigation directions. The two dimensions can be arranged essentially at a right angle to one another. The position of the vehicle is calculated by this offset information in consideration of the offset of the anonymized position information, wherein the reciprocal property ensures that the offset assigned to the anonymized position information can be interpreted both as positive and as negative, depending on the direction of the deviation determined by the offset. “Reciprocal” in the present case means that the determined offset information with negative sign is taken into consideration to determine the offset position information of the vehicle. Thus, for example, if +20 m north, -30 m east with respect to the center point of the grid element representing the rectangular zone was determined as the offset information, the actual position of the vehicle is thus “corrected” by -20 m north, +30 m east, thus by the reciprocal two-dimensional offset information to determine the offset position information of the vehicle. The offset position information is preferably determined by shifting the real vehicle position in the plane of the rasterization by the reciprocal two-dimensional offset information.

The representative grid element can only incompletely depict the zone since the location of the grid element within the surroundings map is exactly defined on the basis of the rasterization algorithm, but the location of the zone within the rasterization can self-evidently vary. In the present case, the offset information is determined to resolve this potential deviation. Cases can thus also be covered in which a center point of the zone is in the vicinity of a grid boundary, and the zone could therefore potentially be assigned to up to four grids representing the zone. A unique assignment of a grid element representing the zone is possible due to the determination of the offset information. In other words, a possibly inaccurate or incorrect grid assignment to a zone becomes unimportant in the further calculation due to the additional offset information, since this inaccuracy or incorrectness can be compensated for by the additional offset information.

The comparison of the anonymized position information of the rectangular zone with the anonymized offset position information of the vehicle preferably specifies that when the anonymized and preferably stored position information of the rectangular zone or the hashed value is identical with the anonymized offset position information of the vehicle, the vehicle is located in the zone, and thus charging of the battery by means of an intelligent charging function is available.

The present invention therefore addresses difficulties in data protection laws, in that complete anonymization of the position data of both the charging station and the vehicle is enabled. An encryption of the position data can be carried out by the hashing, in order to thus make it impossible or at least more difficult for a potential attacker to reach the actual data of the position of the charging station and/or the vehicle from the outside. This is advantageous in particular if the charging station is in a home of a vehicle owner, the geographic position of which is to remain unknown for security reasons or at least is not to be brought into direct connection with the vehicle. Such a data protection is preferred in particular in applications in which the vehicle receives wirelessly, i.e. over the air function instructions, such as charging function protocols, since it would also be possible here for an external attacker to possibly penetrate into a home infrastructure via the vehicle. Furthermore, a zoom level of the rasterization does not have to be selected as particularly high due to the two-dimensional offset information, by which computing power can be saved. The rasterization can be selected to be somewhat rougher, for example, wherein any uncertainties can be compensated for by the two-dimensional offset information. The two-dimensional offset information can in turn be determined in a very simple manner by computer, which only claims a small amount of computing power.

The term vehicle comprises any system for conveying people and goods on roads, such as passenger vehicles, trucks, buses, caravans, motorcycles, on rails, on the water, or in the air. The vehicle can be driven by a hybrid drive or a solely electric drive. Public or private charging stations can use the method. Any battery usable for an electrical or hybrid application, such as a lithium-ion battery, also called a lithium-ion accumulator or lithium accumulator, can be used. The terms “battery” and “accumulator” correspond.

The invention proposes a novel method for storing and checking zones which meet the requirements of data protection laws in that they avoid the linkage of sensitive data. The proposed solution ensures an efficient determination of whether a vehicle is located within a zone while the private sphere of the user is preserved at the same time.

In the present case, a “zone” is designated as a location at which an intelligent charging plan with respect to the charging infrastructure and/or other charging conditions and/or environmental conditions is available.

Grid elements are preferably rectangular sections or tiles which are preferably referred to as tiles. The grid elements or tiles are used to efficiently represent geographic and/or visual data. Tiles are especially used in digital map applications and geo-information systems (GIS). The Earth’s surface is preferably divided into a grid made up of squares or rectangles for the use of tiles. These tiles are preferably generated in various resolutions or zoom levels. At lower zoom levels, a single tile covers a large area of the Earth, while at higher zoom levels more details become visible, since each tile represents a smaller area. Tiles can preferably be present in two main forms: grid data and vector data. Grid tiles preferably comprise pixel-based images, which are preferably used for background maps or satellite images. Vector tiles preferably comprise geometric and attribute-based information which enables maps to be dynamically rendered and adapted.

In some implementations, the grid element representing the rectangular zone is selected from a predetermined rasterization generated by a geographic rasterization algorithm.

The grid element which represents the rectangular zone should ideally originate from an already defined and standardized rasterization. This rasterization is preferably generated with the aid of a geographic rasterization algorithm which divides the Earth’s surface into uniform, previously defined sections. This ensures that the rectangular zone is located in a uniform and consistent system, by which a clear and unique identification and processing within geographic data is enabled.

In some implementations, the rasterization algorithm has a QuadTile algorithm or a geo-hash algorithm.

QuadTiles are preferably a data structure and a format which is used in geo-information systems and cartography to securely store and process geographic data efficiently and with respect to data protection laws. The term “quad” is preferably derived from “quadtree”, a hierarchical data structure which is used for partitioning two-dimensional spaces. In QuadTiles, the Earth’s surface is divided into a hierarchical structure made up of squares which are organized in multiple zoom levels. Each of these squares preferably represents a specific section of the Earth’s surface. This structure enables efficient storage, since data are only stored at the zoom levels which are relevant for the desired resolution, which reduces the memory requirement and enables rapid reloading. More detailed data can be represented precisely by the division into smaller squares at higher zoom levels. QuadTiles cover the entire Earth’s surface and are preferably organized on the basis of the web Mercator projection system or similar projections. Each tile has a unique identifier, which preferably consists of the zoom level and X and Y coordinates. QuadTiles are already used in map services such as Google Maps, Bing Maps, or OpenStreetMap. Moreover, QuadTiles are used for visualizing large geographic data sets such as satellite images or vector data and for space -related analyses in space planning or traffic monitoring. One advantage of QuadTiles is the scalability, since they can process data at different resolutions, and their efficient state, since only required data are loaded. For example, the world is represented as a square at zoom level 0, divided into four squares at zoom level 1, and decomposed into smaller and smaller sections at each further level. At zoom level 1, the two tiles of the zoom level 0 are therefore divided again and now four tiles having the indices 00, 01, 10, and 11 are obtained. This method permits a precise organization, representation, and analysis of large amounts of geographic data. For the present application of QuadTiles, a zoom level of greater than or equal to 18 is particularly preferred. At a zoom level of 18, the tiles preferably have indices having 19 points (such as “0000000000000000001”).

A Geohash or Geohashing is a method for coding geographic coordinates, thus latitude and longitude, in a compact character chain made up of letters and numbers. This character chain is preferably used as a compressed representation of a geographic area which is based on a recursive rasterization of the Earth’s surface. In this case, the Earth is divided into a grid, and each area receives a unique code. The more characters a Geohash contains, the smaller is the area covered and the more accurate the position becomes. The coding is preferably based on a binary representation of the coordinates, wherein latitude and longitude are alternately converted into a unique sequence. This sequence is then preferably translated into a base-32 character chain. The length of the Geohash preferably determines the accuracy here. A Geohash having few characters preferably describes a larger region, while a Geohash having many characters can preferably specify an exact position in the centimeter range. Geohashes enable efficient spatial queries. Due to the property that geographically proximate points share similar Geohash prefixes, neighborhood relationships can preferably be recognized easily, which is particularly useful for search algorithms, as in the present case for the zone matching, and the indexing.

A web Mercator tile system can also be used. Other rasterization algorithms are also possible.

In some implementations, a grid element size of the grid element representing the rectangular zone corresponds to a grid element size of the grid element representing the offset position information.

The grid element size, thus the dimensions or the scale of the grid element that represents the rectangular zone preferably corresponds to the grid element size of the grid element that represents the offset position information. The two grid elements are preferably thus located at the same zoom level. The grid element size determines how finely or coarsely the Earth’s surface or an area will be divided into grid sections. If both grid elements have the same size, it is ensured that the spatial resolution is identical and both grid elements are matched to one another. This enables a direct and precise assignment of the offset position information to the rectangular zone without a conversion or adjustment being required. The accuracy in the calculation, processing, and display of the geographic data is thus increased.

In some implementations, the grid element size is selectable by a zoom level of the geographic rasterization algorithm.

The size of the grid element used to display the geographic data can be determined flexibly by the selection of a zoom level of the geographic rasterization algorithm. A geographic rasterization algorithm divides the Earth‘s surface into grid elements, wherein the size of the grid elements depends on the selected zoom level. Lower zoom levels generate larger grid elements which cover larger geographic areas, while higher zoom levels generate smaller grid elements which enable more detailed information. This flexibility permits the grid element size to be adjusted to the specific requirements of an application. One example of this is the web Mercator tile system as is used in digital maps.

With reference to the example of the QuadTile algorithm, at zoom level 0, the entire Earth’s surface is divided into a single large square which covers the entire globe. At zoom level 1, this square is divided into four equal squares so that each of these tiles represents a fourth of the Earth’s surface. At zoom level 2, each of the tiles from zoom level 1 is again divided into four squares, so that the Earth’s surface now consists of a total of 16 tiles. The division is continued at higher zoom levels. At zoom level 10, for example, the Earth consists of 1024 x 1024 tiles, wherein each tile covers a surface of a few kilometers in width. At zoom level 15, the division is so fine that each tile represents an area of approximately 100 m x 100 m.

In some implementations, the grid element size corresponds to a size of the rectangular zone or to deviate by up to 10%, preferably by up to 20%, particularly preferably by up to 30% from the size of the rectangular zone.

In other words, the grid element size can essentially correspond to the size of the rectangular zone. The grid element size preferably describes a surface extension or a surface area of the grid element. The grid element size can also be determined by the dimensions of the grid element, for example, its length and width. The size of the zone preferably describes a surface extension or a surface area of the zone. The size of the zone can also be determined by the dimensions of the zone, for example, its length and width.

In some implementations, the two-dimensional offset information for the rectangular zone is determined in the dimensions of a plane of a rasterization of the surroundings map associated with the grid elements to be represented.

This means that the two-dimensional offset information which describes the deviation or the distance within a rectangular zone is calculated in relation to the dimension of a plane which is part of the rasterization of the surroundings map. The rasterization of the surroundings map is used here as a reference system, and the offset information is determined within the same spatial division which specifies the grid elements. This ensures that the offset information matches precisely with the structure and the scales of the grid used.

It is moreover preferred for the method to furthermore have a further encryption of the anonymized position information and/or the anonymized offset position information by means of a pepper value or by means of a vehicle VIN of the vehicle.

This means that the already anonymized or hashed position information and/or the anonymized offset position information is additionally protected by a further encryption in that, for example, a so-called pepper value or the vehicle identification number (VIN) is used. A pepper value is a confidential random value which is incorporated in addition to the original information in the encryption process to increase the level of security. The vehicle VIN is a unique identifier which is assigned to each vehicle and can also be used as an additional input for the encryption. This additional encryption ensures that even in the event of an attack on the system, the position information and/or the anonymized offset position information cannot be decrypted without knowledge of the pepper value or the VIN.

One example of the use of a pepper value: Hashed position information such as “a3f2c9” is encrypted further by the combination with a secret pepper value such as “x7g9k2”, so that the final result is a more complex hash which cannot be traced back even if the original hash is known.

One example of the use of the vehicle VIN: The hashed position information “a3f2c9” is additionally combined with the VIN of the vehicle, for example, “1HGCM82633A123456”, and encrypted again to generate a new hash. It is thus ensured that the position information can only be interpreted in the context of the specific vehicle.

It is furthermore preferred for the cryptographic algorithm to have an SHA-256 algorithm or an SHA-1 algorithm or an SHA-224 algorithm or an SHA-384 algorithm or an SHA-512 algorithm or an SHA-3 algorithm or an RIPEMD-160 algorithm or a BLAKE2 algorithm or a BLAKE3 algorithm or a Whirlpool algorithm or an MD5 algorithm or a Tiger algorithm.

SHA-256 is preferably a cryptographic hash algorithm which is part of the SHA family (Secure Hash Algorithm) and is preferably used for data integrity and authentication. Similar algorithms are, among others, SHA-1, an older algorithm having a 160-bit hash value. SHA-224 is a variant of SHA-256 having a 224-bit hash value. SHA-384 and SHA-512 are variants having longer hash values of 384 and 512, wherein SHA-512 is suitable for particularly high security requirements. SHA-3, a newer member of the family, is based on the Keccak algorithm and offers additional security due to a different internal structure. Further similar algorithms are RIPEMD-160, an algorithm having a 160-bit hash value, which was developed as an alternative to SHA-1, and BLAKE2. BLAKE3 is a refinement of BLAKE2, which is even faster and supports parallel processing. Whirlpool, an algorithm having a 512-bit hash value, also offers a high level of security. Algorithms such as MD5, which generates a 128-bit hash value, are also possible. Tiger, an algorithm which was optimized for 64-bit systems, preferably offers a high speed.

It is furthermore preferred for the method to further include charging of the battery of the vehicle by means of the intelligent charging function of the charging station if the anonymized position information of the rectangular zone corresponds with the anonymized offset position information of the vehicle.

If the vehicle is thus located in a zone in which intelligent charging is available, the charging function can be started by the user of the vehicle. Greatly varying charging technologies are conceivable here, from cable-based charging to inductive charging. Intelligent charging is preferably controlled by charging protocols and/or charging signals which can be provided directly to the vehicle.

It is furthermore preferred for the intelligent charging function to be transmitted on the basis of charging signals and/or a charging plan via a vehicle producer-side back end wirelessly to the vehicle and/or to the charging station and to be executed by a charging controller of the vehicle and/or the charging station if the anonymized position information of the rectangular zone corresponds with the anonymized offset position information of the vehicle.

The charging controller of the vehicle or the charging station then executes the charging function based on the received signals or the plan. This enables a central control and optimization of the charging procedure, for example, in consideration of energy prices, grid load, or charging preferences. One example of the transmission of charging signals: A vehicle receives a signal via the backend, which shifts the charging procedure to a specific period of time in which the electricity rate is lower, for example, between 11 PM and 5 AM. The charging controller of the vehicle waits accordingly before it starts the charging procedure. One example of the transmission of a charging plan: A charging plan is transmitted to the charging station via the backend, which defines that the vehicle will be charged to 50% in order to ensure energy for a short journey, and the remainder of the charging procedure takes place at a later point in time during lower grid loads. The charging station adjusts the charging power according to the plan and communicates this with the vehicle.

The invention also comprises a system for anonymized matching of a position of a vehicle with a rectangular zone within a surroundings map, wherein an intelligent charging function of a charging station for charging a battery of the vehicle is available in the rectangular zone. The system comprises a provision unit, which is configured to provide anonymized position information of the rectangular zone, wherein the anonymized position information of the rectangular zone is generated by hashing a grid element representing the rectangular zone by means of a cryptographic algorithm, providing two-dimensional offset information for the rectangular zone, wherein the two-dimensional offset information describes an offset between a center point of the grid element representing the rectangular zone and a center point of the rectangular zone and providing position information of the vehicle within the surroundings map. Furthermore, the system comprises an evaluation unit which is configured to determine offset position information of the vehicle using the reciprocal two-dimensional offset information, to generate anonymized offset position information to the offset position information of the vehicle by hashing a grid element representing the offset position information by means of a cryptographic algorithm, and to compare the anonymized position information of the rectangular zone with the anonymized offset position information of the vehicle for the anonymized matching of the position of the vehicle with the position area of the rectangular zone. If the anonymized position information of the rectangular zone corresponds with the anonymized offset position information of the vehicle, it is assumed that the position of the vehicle lies within the position area of the rectangular zone. The position of the vehicle is then considered to be matched with the position area of the rectangular zone.

The invention also comprises a computer program product comprising commands which, when the method is carried out by a computer comprising a processor, cause the computer to carry out the method.

The invention additionally comprises a computer-readable medium on which the computer program product is stored.

Exemplary embodiments of the invention are shown in the figures and will be described in more detail hereinafter. Identical reference signs are used for identical and identically-acting elements hereinafter, if not indicated otherwise.

In the figures other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic block diagram of a system according to one form of the invention which perform method steps according to the invention, and

FIG. 2 shows a schematic representation of a surroundings map, on the basis of which the method according to the invention can be explained.

### DETAILED DESCRIPTION OF THE DRAWINGS

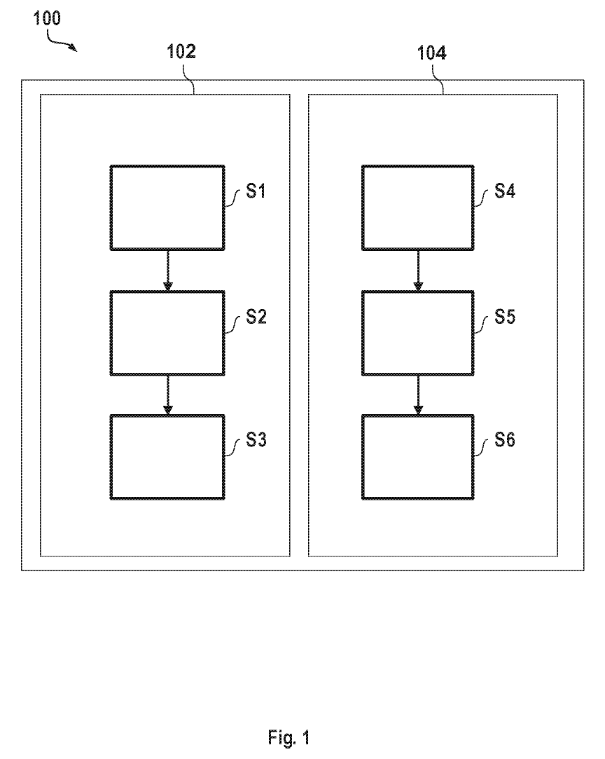

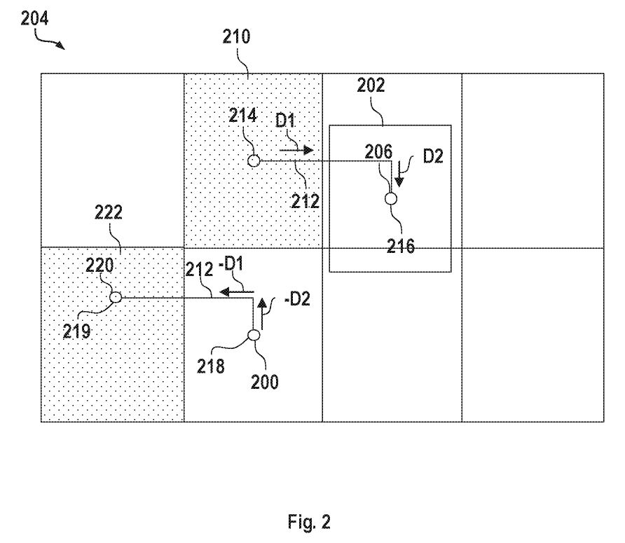

The invention will be explained in consideration of FIGS. 1 and 2 together. FIG. 1 shows a schematic block diagram of a present system 100. The system 100 is configured to carry out the present method or the present method steps.

The system 100 is configured for anonymized matching of a position of a vehicle 200 with a rectangular zone 202 within a surroundings map 204. An intelligent charging function of a charging station 206 for charging a battery of the vehicle 200 is available in the rectangular zone 202.

The system 100 comprises a provision unit 102 (which may be a computing device comprising a processor and memory), which is configured, in a step S1, to provide anonymized position information 208 of the rectangular zone 202, wherein the anonymized position information 208 of the rectangular zone 202 is generated by hashing a grid element 210 representing the rectangular zone 202 by means of a cryptographic algorithm. The cryptographic algorithm can be executable on the system 100. Alternatively, the cryptographic algorithm can also be executable on another system, so that only the already anonymized or hashed position information 208 is provided to the system 100. This can optionally save computing capacity. The cryptographic algorithm has, for example, an SHA-256 algorithm or an SHA-1 algorithm or an SHA-224 algorithm or an SHA-384 algorithm or an SHA-512 algorithm or an SHA-3 algorithm or an RIPEMD-160 algorithm or a BLAKE2 algorithm or a BLAKE3 algorithm or a Whirlpool algorithm or an MD5 algorithm or a Tiger algorithm.

The grid element 210 representing the rectangular zone 202 is selected from a predetermined rasterization generated by a geographic rasterization algorithm. The rasterization algorithm can include a QuadTile algorithm or a Geohash algorithm. The rasterization algorithm can be executable on the system 100. Alternatively, the rasterization algorithm can also be executable on another system.

The provision unit 102 (which may be a computing device comprising a processor and memory) is configured, in a step S2, to provide two-dimensional offset information 212 for the rectangular zone 202, wherein the two-dimensional offset information 212 describes an offset between a center point 214 of the grid element 210 representing the rectangular zone 202 and a center point 216 of the rectangular zone 202. The two dimensions in which the offset information 212 is determined are identified by D1, D2. The two-dimensional offset information 212 for the rectangular zone 202 is preferably determined here in the dimensions of a plane of a rasterization of the surroundings map 204 associated with the representing grid element 210, 222. The dimensions D1, D2 can be arranged essentially at a right angle to one another as shown in FIG. 2.

The provision unit 102 is configured, in a step S3, to provide position information 218 of the vehicle 200 within the surroundings map 204.

Steps S1 to S3 do not have to be carried out in the order listed, but rather can vary arbitrarily.

Furthermore, the system has an evaluation unit 104 (which may be a computing device comprising a processor and memory) which is configured to determine, in a step S4, offset position information 219 of the vehicle 200 using the reciprocal two-dimensional offset information 212. The reciprocal incorporation of the offset position information 219 is indicated by means of -D1, -D2.

The evaluation unit 104 is furthermore configured, in a step S5, to generate anonymized offset position information 220 for the offset position information 219 of the vehicle 200 by hashing a grid element 222 representing the offset position information 219 by means of a cryptographic algorithm. This is preferably the same cryptographic algorithm as in step S1. A grid element size of the grid element 210 representing the rectangular zone 212 preferably corresponds here to a grid element size of the grid element 222 representing the offset position information 219. The grid element size is preferably selectable here by a zoom level of the geographic rasterization algorithm.

The evaluation unit 104 is furthermore configured, in a step S6, to compare the anonymized position information 208 of the rectangular zone 202 with the anonymized offset position information 220 of the vehicle 200 for the anonymized matching of the position of the vehicle 200 with the position area of the rectangular zone 202. If the anonymized position information 208 of the rectangular zone 202 corresponds with the anonymized offset position information 220 of the vehicle 200, it is assumed that the position of the vehicle 200 lies within the position area of the rectangular zone 202.

The grid element size of a size of the rectangular zone 202 corresponds to the size of the rectangular zone 202 or deviates by up to 10%, preferably by up to 20%, particularly preferably by up to 30% from the size of the rectangular zone 202.

The anonymized position information 208 and/or the anonymized offset position information 220 can be further encrypted by means of a pepper value or by means of a vehicle identification number and thus further protected.

If the anonymized position information 208 of the rectangular zone 202 corresponds with the anonymized offset position information 220 of the vehicle 200, the battery of the vehicle 200 can be charged by means of the intelligent charging function of the charging station 206. The intelligent charging function is, for example, transmitted wirelessly to the vehicle 200 and/or to the charging station 206 on the basis of charging signals and/or a charging plan via a vehicle producer-side backend and executed by a charging controller of the vehicle 200 and/or the charging station 206.

The features of the invention described with reference to the illustrated embodiments can also be present in other embodiments of the invention, unless indicated otherwise or intrinsically forbidden for technical reasons.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 system

102 provision unit

104 evaluation unit

200 vehicle

202 zone

204 surroundings map

206 charging station

208 anonymized position information

210 grid element

212 two-dimensional offset information

214 center point

216 center point

218 position information

219 offset position information

220 anonymized offset position information

222 further grid element

D1 dimension

D2 dimension

S1 method step

S2 method step

S3 method step

S4 method step

S5 method step

S6 method step

What is claimed is:

1. A computer-implemented method for anonymized matching of a position of a vehicle with a position area of a rectangular zone within a surroundings map, wherein a charging station configured to provide an intelligent charging function for charging a battery of the vehicle is available in the rectangular zone, the method comprising steps of:
providing anonymized position information of the rectangular zone, wherein the anonymized position information of the rectangular zone is generated by hashing a grid element representing the rectangular zone utilizing a cryptographic algorithm;
providing two-dimensional offset information for the rectangular zone, wherein the two-dimensional offset information describes an offset between a center point of the grid element representing the rectangular zone and a center point of the rectangular zone;
providing position information of the vehicle within the surroundings map;
determining offset position information of the vehicle using the reciprocal two-dimensional offset information;
generating anonymized offset position information for the offset position information of the vehicle by hashing a grid element representing the offset position information utilizing the cryptographic algorithm; and
comparing the anonymized position information of the rectangular zone with the anonymized offset position information of the vehicle for the anonymized matching of the position of the vehicle with the position area of the rectangular zone.

2. The method according to claim 1, wherein the grid element representing the rectangular zone is selected from a predetermined rasterization generated by a geographic rasterization algorithm.

3. The method according to claim 2, wherein the rasterization algorithm includes a QuadTile algorithm or a Geohash algorithm.

4. The method according to claim 2, wherein a grid element size of the grid element representing the rectangular zone corresponds to a grid element size of the grid element representing the offset position information.

5. The method according to claim 4, wherein the grid element size is selectable by a zoom level of the geographic rasterization algorithm.

6. The method according to claim 4, wherein the grid element size corresponds to a size of the rectangular zone or deviates by up to 30% from the size of the rectangular zone.

7. The method according to claim 1, wherein the two-dimensional offset information for the rectangular zone is determined in the dimensions of a plane of a rasterization of the surroundings map associated with the representing grid element.

8. The method according to claim 1, further comprising a further encryption of at least one of the anonymized position information or the anonymized offset position information utilizing a pepper value.

9. The method of claim 1, further comprising:
including a further encryption of at least one of the anonymized position information or the anonymized offset position information utilizing a vehicle VIN of the vehicle.

10. The method according to claim 1, wherein the cryptographic algorithm has an SHA-256 algorithm or an SHA-1 algorithm or an SHA-224 algorithm or an SHA-384 algorithm or an SHA-512 algorithm or an SHA-3 algorithm or an RIPEMD-160 algorithm or a BLAKE2 algorithm or a BLAKE3 algorithm or a Whirlpool algorithm or an MD5 algorithm or a Tiger algorithm.

11. The method according to claim 1, further comprising:
charging the battery of the vehicle by means of the intelligent charging function of the charging station when the anonymized position information of the rectangular zone corresponds with the anonymized offset position information of the vehicle.

12. The method of claim 1, wherein the intelligent charging function is transmitted wirelessly to at least one of the vehicle or the charging station on the basis of at least one of charging signals or a charging plan via a vehicle producer-side backend and is executed by at least one of a charging controller of the vehicle or the charging station when the anonymized position information of the rectangular zone corresponds with the anonymized offset position information of the vehicle.

13. A system for anonymized matching of a position of a vehicle with a position area of a rectangular zone within a surroundings map, wherein a charging station that is configured to provide an intelligent charging function for charging a battery of the vehicle is available in the rectangular zone, the system comprising:
a provision unit configured to:
provide anonymized position information of the rectangular zone, wherein the anonymized position information of the rectangular zone (202) is generated by hashing a grid element representing the rectangular zone utilizing a cryptographic algorithm;
provide two-dimensional offset information for the rectangular zone, wherein the two-dimensional offset information describes an offset between a center point of the grid element representing the rectangular zone and a center point of the rectangular zone; and
provide position information of the vehicle within the surroundings map;
an evaluation unit configured to:
determine offset position information of the vehicle using the reciprocal two-dimensional offset information;
generate anonymized offset position information for the offset position information of the vehicle by hashing a grid element representing the offset position information by means of the cryptographic algorithm; and
compare the anonymized position information of the rectangular zone with the anonymized offset position information of the vehicle for the anonymized matching of the position of the vehicle with the position area of the rectangular zone.

14. A computer-readable storage medium comprising a set of instructions that, when executed by a processor, cause the processor to performs of the method of claim 1.
